(19) United States
(12) Patent Application Publication
(10) Pub. No.: US 2007/0162313 A1
(43) Pub. Date: Jul. 12, 2007

(54) Certificate holder liability insurance

(76) Inventor: Charles Loring Young JR., Lake Forest, CA (US)

Correspondence Address: Charles L. Young, Jr., 25761 Le Parc #1, Lake Forest, CA, 92630, US

(21) Appl. No.: 11/181,467

(22) Filed: Jul. 15, 2005

(51) Int. Cl. G06Q 40/00

(52) U.S. Cl. 705/4

(57) ABSTRACT

The Certificate Holder Liability Insurance policy is a new concept in insurance coverage, a new approach to handling the potential coverage problems presented to certificate holders when accepting certificates of insurance from certificate providers and a better means to assure certificate holders that the coverage they require and depend on in insurance policies purchased by others will provide the protection they seek when requiring insurance of third parties.

### CROSS REFERENCE TO RELATED APPLICATIONS

None.

### FEDERALLY SPONSORED RESEARCH OR DEVELOPMENT

None. No Federally sponsored research or development has been used in developing this invention.

### BACKGROUND OF THE INVENTION

This patent application seeks a patent on a business process that ensures that the insurance shown on a certificate of insurance provided by one party to another party (the Certificate Holder) either provides the liability and/or workers compensation coverage shown, or the Certificate Liability Insurance policy will provide such insurance for the benefit of the Certificate Holder in its stead. This assures the certificate holder with certainty that the protection cited in the certificate will be available in the event of loss.

When property owners, general contractors and similar entities require evidence of insurance of third parties, such as a tenant or a subcontractor, certificates of insurance (certificates) are commonly provided by tenants or subcontractors to evidence that the insurance required of them is in place. The most common form of certificate is the ACORD™ form.

However, certificates, as stated in the ACORD™ certificate form, only provide evidence that the insurance policies shown in the certificate are in force on the date the certificate is issued. A certificate also specifically states that it confers no rights upon the certificate holder. As such, certificates provide very limited benefit and do not guarantee the insurance shown will be in force when needed.

Certificates also require “certificate holders” to spend time reviewing certificates to see that the insurance shown complies with the certificate holder's requirements and time following up with third parties to obtain adequate evidence of insurance when the certificate is not in compliance.

In contract agreements, the certificate holder generally requires new certificates of the insurance certificate provider at least fifteen days prior to the expiration date on each policy shown on the certificate. However, insurers frequently fail to renew insurance policies until the last minute and frequently do not assign policy numbers or provide copies of the renewal policy for an extended period after the renewal date. Due to this, insurance brokers are often unable to issue new certificates prior to the policy expiration date and certificate holders are unable to determine if the certificate provider has continuing coverage. This aspect also adds to the certificate holder's administrative costs and leaves the certificate holder in a uncertain position in terms of the insurance protection in force.

### BRIEF SUMMARY OF THE INVENTION

Certificate Holder Liability Insurance provides a guarantee that the insurance shown (or its equivalent) will be available to protect the “certificate holder” in the event the insurance shown in the certificate:
Is not in force on the date a loss.
Has limits less than those stated.
Has a deductible that is not shown in the certificate.
Has a higher deductible than the deductible shown on the certificate.
Is excess to the certificate holders insurance.
Has an exclusion that would not normally apply in a standard commercial general liability, automobile liability or workers compensation policy.

The Certificate Holder Liability Insurance policy also provides for continuing coverage for the sole benefit of the certificate holder based on the limits and coverage shown in the certificate for a period of 15 days after the policy expiration date shown. This eliminates the uncertainty the certificate holder may have in relation to the certificate holder's inability to provide new certificates of insurance on time. (No coverage is afforded to the certificate provider in this regard.)

### DETAILED DESCRIPTION OF THE INVENTION

A copy of the Certificate Holder Liability Insurance policy is attached to this application. The Certificate Holder Liability policy provides the certificate holder with the same insurance protection they would have from the insurance policies shown in the certificate if those policies are not available to protect the certificate holder at the time of loss.

To obtain Certificate Holder Liability Insurance, the “certificate holder” simply applies to the insurer offering the Certificate Holder Liability Insurance and pays an initial deposit premium. From that point on, the “certificate holder” submits a copy of each certificate for which the “certificate holder” seeks coverage and pays a small additional premium for each certificate that is to be covered. Upon submission of the certificate by the Certificate Holder Liability Insurance insurer, the “certificate holder” has insurance coverage for that certificate until the termination dates shown for the insurance policies shown on the certificate (plus fifteen days). Other than some

minimum standards required of the certificate holder, the certificate holder is also relieved of amending the certificate or verifying and following up on outstanding issues in relation to the certificate (thus reducing the certificate holder's administrative costs).

For a small added premium, the certificate provider (the third party providing the certificate) can obtain a waiver from the insurer in the event coverage is not in force due to any reason other than deliberate cancellation or a voluntary reduction in coverage. (If this waiver is not purchased, the Certificate Holder Liability insurer retains the right to seek recovery from the certificate provider for any payments the insurer makes under the policy.) It is of advantage to the certificate provider to obtain this waiver as they generally have limited control over coverage changes, reductions or cancellations their own insurer may make to their policies.

There is no insurance policy written that provides an assurance of coverage based on a Certificate of Insurance. As such, this invention is unique and fills a gap that has presented a difficulty to property owners and others that want assurance that the insurance represented by certificates of insurance will be available to them.

The Certificate Holder Liability policy will be underwritten by the Certificate Holder Liability insurer based on the type of risk associated with the Certificate Provider's operations. Additional requests for covering the certificate holder for protection afforded to them through specialized policies required of certificate holders (such as pollution liability, asbestos liability, professional liability, etc) will be underwritten on a case by case basis. No protection will apply to benefit the certificate provider with these specialized policies.

What I claim as my invention is:

1. The business concept and process for using a separate liability policy owned by the certificate holder to protect their primary insurance program and address the risk that the certificate provider's insurance is not in effect, available or as stated in the certificate of insurance provided to the certificate holder.

2. The Certificate Holder Liability insurance policy (as attached and revised versions) for addressing the concerns in claim 1 above.

3. Endorsements designed to amend the Certificate Holder Liability insurance policy.
